(19) United States
(12) Patent Application Publication
(10) Pub. No.: US 2008/0309482 A1
(43) Pub. Date: Dec. 18, 2008

(54) Tunnel Activity Sensing System

(75) Inventors: Mark D. Asplund, Albuquerque, NM (US); Randy W. Lokken, Minnetonka, MN (US); Ron Lewandowski, New Brighton, MN (US); William J. Klein, Stillwater, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/041,734

(22) Filed: Mar. 4, 2008

Related U.S. Application Data
(60) Provisional application No. 60/896,168, filed on Mar. 21, 2007.

(51) Int. Cl. G08B 13/00; G08B 1/08

(52) U.S. Cl. 340/539.22; 340/539.1; 340/541

(57) ABSTRACT

A system for detection of underground intrusions and reporting those intrusions, including a plurality of sensor packages planted underground, the plurality of sensor packages providing a corresponding plurality of detection outputs to a controller, the controller operative to receive at least one of the plurality of detection outputs and to provide a high speed output indication of intrusion presence.

### FIELD

The present invention relates generally to disturbance detection and warning systems. More particularly, the present invention relates to a network-based underground warning and reporting system and method.

### BACKGROUND

Border patrol has become an increasingly important issue for governments seeking to control persons entering and leaving their respective countries. Border control can be especially difficult when the border concerned spans a vast, largely unpopulated terrain, such as the 6,000 miles of border between the United States and Mexico. To help reduce illegal crossings, more officers are being hired, walls are being installed, and more technology is being applied to border enforcement.

There is a need for a sensor system that can provide unmanned coverage of underground areas for long periods of time. It is highly desirable to provide a new and improved network for providing remote supervision of underground intrusions. It is thus highly desirable to provide a new and improved communication network between a plurality of underground sensors at different locations and a controller, where the network utilizes a plurality of sensory displays, signals and prompts to supervise and report intrusions and intrusion information at spaced remote locations.

### SUMMARY

The present invention overcomes many of the disadvantages of the prior art by providing a tunnel activity detection system designed to detect intrusions within an area, to inform users monitoring the area when an intrusion has occurred, and to inform the users of the location of the intrusion.

The tunnel activity detection system includes one or more sensor packages and a local controller. Each of the one or more sensor packages are planted underground in a target area in which intrusion detection is desired. A user will then associate each sensor package with the local controller to form a wireless network. The sensors within the sensor packages are connected as routing nodes via a radio network.

The sensor network is configured for flexible use. The sensors are spaced to allow for messaging around a disabled sensor node. Additionally, low duty cycle sensors may be placed among sensors with longer duty cycles to prolong battery life.

When a sensor detects an intrusion, an appropriate signal is transmitted to the controller via the radio network. A display associated with the controller allows the user to view details concerning the intrusion. These details may include information regarding the time and location of the intrusion.

The display on the local controller may be interactive display, wherein the user can select screen options from an initial screen. The screen options may be, for example, an alert screen, an add sensor screen, a command screen, or a network status screen. The alert screen may show information regarding the last alert and allow the user to further select an image screen to view images of an intrusion. The add sensor screen allows the user to add more sensors to the network. The command screen allows the user to change the status of a sensor; a sensor could be set to a number of different modes. For example, the sensor could be either active or inactive, depending on whether the particular area within which the sensor is placed requires surveillance. A network status screen may provide the user with information regarding the mode set for each sensor and the amount of battery remaining in each sensor. In addition, the local controller may inform the user of an intrusion with any one of numerous types of annunciators, such as a vibration annunciator.

The local controller may be housed within a computer, such as a laptop or desktop computer. The controller may also be housed within a personal digital assistant.

Natural disturbances, such as earthquakes, do not exhibit a prolonged uniform pulse pattern as do other disturbances, such as pedestrian disturbances. Thus natural disturbances can be readily identified and rejected by a system designed to detect pedestrian disturbances.

The intrusion detection and reporting network may have many practical applications. For example, the intrusion detection and reporting network can be applied to military, home, industrial, corporate, neighborhood, or penitentiary use.

### BRIEF DESCRIPTION OF THE DRAWINGS

Various embodiments are described herein with reference to the following drawings. Certain aspects of the drawings are depicted in a simplified way for reason of clarity. Not all alternatives and options are shown in the drawings and, therefore, the invention is not limited in scope to the content of the drawings. In the drawings:

FIG. 1 depicts a tunnel activity sensor system according to one embodiment of the present invention;

FIG. 2 depicts a tunnel activity sensor system according to one embodiment of the present invention;

FIGS. 3a-c depict various exemplary embodiments of sensor packages; and

FIG. 4 is a simplified block diagram of an exemplary display screen.

### DETAILED DESCRIPTION

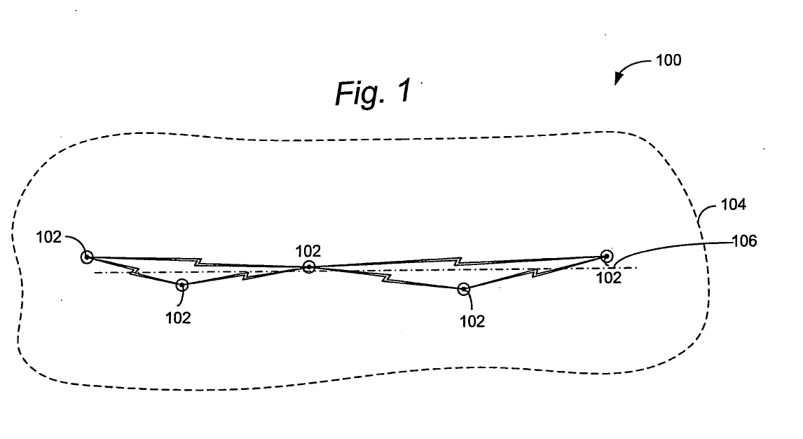

FIG. 1 depicts a tunnel activity sensor system 100. Tunnel activity sensor system 100 includes a plurality of sensor packages 102 arranged across a target area 104, as shown in FIG. 1. The plurality of sensor packages 102 may communicate wirelessly with one another and/or with other devices in system 100. For example, the plurality of sensor packages 102 may communicate with a local controller 106.

The plurality of sensor packages 102 and other devices preferably communicate using a self-forming, self-healing mesh ad-hoc network. While many protocols exist for such networks, presently preferred protocols are in accordance with IEEE 802.15 Wireless Personal Area Network (WPAN) standards. For example, the ZigBee suite of communications, based on the IEEE 802.15.4 standard is a desirable protocol suite due to its suitability for low-power, low data-rate applications. However, other communication systems may also be used.

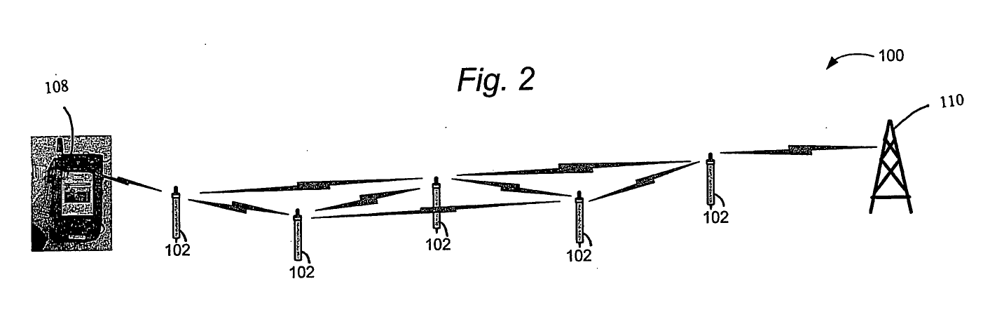

FIG. 2 is a simplified diagram illustrating the tunnel activity sensor system 100 of FIG. 1. As shown in FIG. 2, local controller 106 may comprise a display 108. In addition, the plurality of sensor packages 102 may communicate with an existing security infrastructure 110. Sensor packages 102 may be in a staggered formation, as in the configuration shown in FIG. 2. However, the plurality of sensor packages 102 may also be arranged in a number of other configurations. As an example configuration alternative, the plurality of sensor packages 102 may be arranged in a straight line in series. As another alternative, the sensor packages 102 may be arranged to form a circle or square.

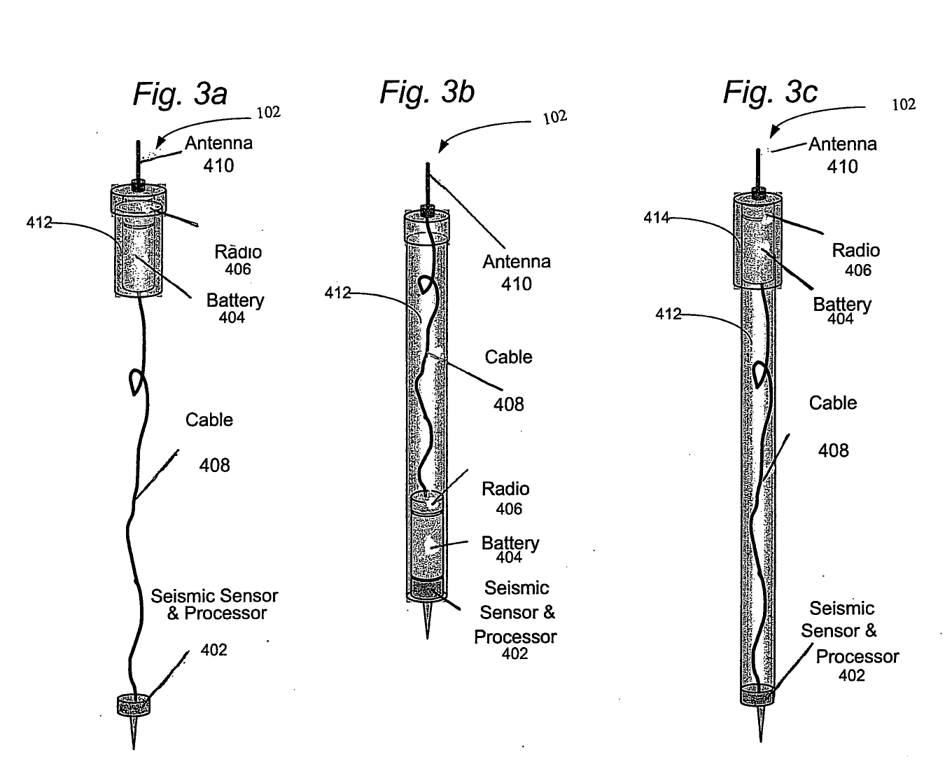

FIGS. 3a-c illustrate possible configurations for the plurality of sensor packages 102. Each sensor package of the plurality of sensor packages 102 may comprise a seismic sensor and processor 402, a battery 404, a radio 406, a cable 408, and an antenna 410. Seismic sensor and processor 402 should be in direct or indirect solid physical contact with the ground so as to improve sensing capabilities. With the possible exception of the antenna 410, each of these components may be substantially enclosed within an enclosure 412. FIG. 3a shows enclosure 412 enclosing radio 406 and battery 404, leaving cable 408 and seismic sensor and processor 402 open to the surrounding terrain. FIGS. 3b and 3c show enclosure 412 enclosing cable 408, radio 406, battery 404, and at least a portion of seismic sensor and processor 402. Enclosure 412 may be a PVC pipe having an inner diameter and length sufficient to accommodate the aforementioned components. Enclosure 412 protects the components from possible damaging forces. In an alternative embodiment, two enclosures 412 may be used. A first enclosure containing sensor package 102 could be permanently buried in a hole and the hole filled with dirt. A second enclosure may contain the radio 406 and battery 404 buried near the surface. A cable attached to antenna 410 and running through the first enclosure could then couple the first enclosure to the second enclosure. In some embodiments, antenna 410 may be a retractable antenna.

Radio 406, in combination with the processor and software, allows each sensor package of the plurality of sensor packages 102 to function as a network router, relaying data from adjacent nodes. Thus, the network can be dynamically configured. Radio 406 is preferably a radio offered by Honeywell International Inc. For example, a 100 mW radio may be used for communications between the plurality of sensor packages 102. Higher-powered radios may be used if greater communication range is desired. However, with higher-powered radios, the life of battery 404 will be shortened. A 100 mW radio is preferably used for communications up to approximately 200 meters. A 250 mW radio may be used for communications up to around 400 meters. A 500 mW radio may be used for communications up to around 500 meters. As the distance between neighboring sensor packages 102 increases, however, the ability to sense very small disturbances at the midpoints between sensor packages 102 may decrease.

Seismic sensor and processor 402 preferably comprises a MEMS accelerometer capable of sensing micro-g disturbances. Such sensors are offered by Honeywell International Inc., for example, the assignee of the present invention. Other sensors capable of detecting micro-g disturbances may also be used. The seismic sensors may use any of a number of technologies including geophones, accelerometers, seismometers, or other technologies capable of detecting digging activities. Additional sensors capable of detecting tunnels or tunneling may be included in the sensor package to augment the seismic sensor. These may include acoustic sensors, magnetic anomaly sensors, density anomaly sensors, or other sensors. Optimal sensors will exhibit the requisite sensitivity with minimal power consumption. The sensors are preferably low duty cycle sensors that “listen” for digging during only a fraction of each hour. For example, each sensor may actively sense for only one minute out of each hour, in order to prolong battery life. Suspicious signals could trigger longer duty cycles for the detecting sensor package, as well as adjacent sensor packages 102. Processing may include executing situational understanding and control software to assist in characterizing and/or identifying detected disturbances. In an alternative embodiment, the primary characterizing and identifying functions are carried out by the local controller 106. Processing may also include accelerometer calibration, RF processing, and other processing.

Each sensor package of the plurality of sensor packages 102 may be installed so that substantially the entire assembly is below ground, with the exception of antenna 410. Alternatively, each of the plurality of sensor packages 102 may be only partly below ground and partly above ground, to improve the coverage area of antenna 410. For security applications, however, installation is preferably substantially below ground to prevent detection by possible intruders. The plurality of sensor packages 102 may be installed by boring a hole, extending the retractable antenna 410, and placing the sensor package in the hole. Alternatively, if the enclosure is of sufficient strength and rigidity, each of the plurality of sensor packages 102 may be pushed, driven, or screwed into soft soil or sand, without boring an installation hole beforehand.

The plurality of sensor packages 102 are preferably arranged around target area 104 in such a way that at least two sensor packages 102 will detect any particular underground disturbance occurring below the target area, to the depth at which the sensor packages are able to sense such a disturbance. For most applications, a sensing depth of up to about 30 meters may be sufficient. Increasing the density of sensor packages 102 placed in the target area 104 may lead to improved depth consistency, as well as deeper sensing capabilities. The underlying geology of any particular area will affect sensing depths and characteristics. Suitable distances between neighboring sensor packages 102 may be on the order of hundreds of meters (e.g. 200 meters between neighboring sensor packages 102). In a basic implementation, a single sensor package and a single local controller 106 make up the entire system.

To assist in locating detected disturbances, the location of installed sensor packages 102 should be recorded. Triangulation may be used to identify approximate locations for possible tunneling activity. As an alternative, each sensor package of the plurality of sensor packages 102 could include a GPS module to communicate its location as appropriate.

For a border security application, the plurality of sensor packages 102 may be placed at various points along a border to be secured. The plurality of sensor packages 102 may be emplaced in any configuration desired for a given geology, desired detection range, and expected tunnel depth as long as communication is established with the radio network.

The local controller 106 functions, in part, as the primary situational awareness display and preferably comprises a short-haul radio, situational understanding software (e.g. disturbance characterization/identification modules), a display 108 and input and output components. Local controller 106 communicates with the networked sensor packages 102 to receive alerts and to assist in controlling and monitoring the system 100. Alerts may indicate the possible detection of an underground disturbance, a faulty sensor package (as detected by neighboring sensor packages, for example), or a low-battery condition. In addition, local controller 106 may interface with other devices and systems, such as intrusion and/or imaging sensors, as well as other user controller devices or a central facility.

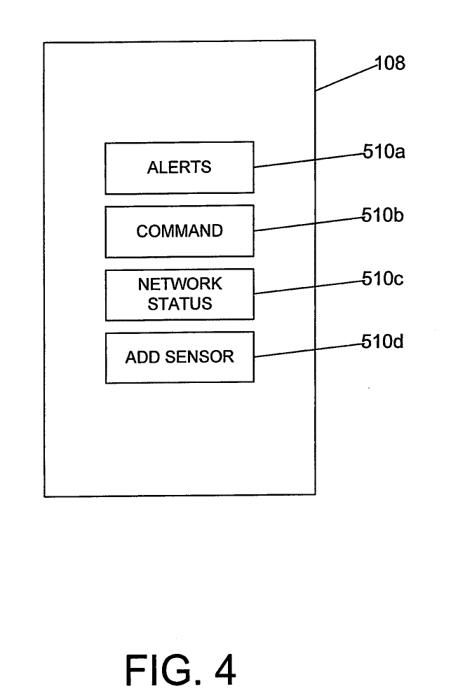

In one embodiment, local controller 106 is housed within a computer. In another embodiment, local controller 106 is housed within a handheld device, for example, a personal digital assistant (“PDA”) having integrated short-haul communications capabilities. Local controller 106 may also be a housed within a ruggedized PDA, (“RPDA”) which comprises a hardened case for rugged and dangerous environments. The user may then view information regarding an intrusion via display 108. Display 108 may be a graphical user interface (“GUI”), and may provide screens for network status, command and control, adding a sensor (i.e., missing loading), alerts, and disturbance characterization, identification and location information. Display 108 may show details about the intrusion including information regarding the time of the intrusion. Display 108 may show information regarding the location of the intrusion. For example, details regarding the location of the intrusion may include geographic coordinates. Some exemplary display 108 screens are shown in FIG. 4. FIG. 4 depicts various functions that may be implemented by local controller 106 that are used to implement the system of FIG. 1. Display 108 may show a plurality of screen options. Although four screen options are depicted in FIG. 4, display 108 is not limited to four screen options, and a number of other screen options may be present. A user may select one of the plurality of screen options from display 108. The plurality of screen options shown in FIG. 4 are an alerts screen 510a, an add sensor screen 510b, a command screen 510c, and a network status screen 510d. Although only these particular screen options are shown, the display is not limited to these specific options and other options may be included or substituted.

Alerts screen 510a may show information regarding the last intrusion alert. Alerts screen 510a may also show or provide access to any of the location information of an intrusion previously discussed.

Add sensor screen 510b allows a user to add more sensors to the network.

A sensor may be set to a number of different modes; command screen 510c allows a user to change the sensor mode. As an example, a sensor could be set to be either active or inactive, depending on whether that particular area within which the sensor is placed requires surveillance.

Network status screen 510d may provide a user with information regarding the mode set for each sensor, the amount of battery remaining in each sensor, as well as the type of sensor.

In addition to providing location information, local controller 106 may vibrate to alert a user of an intrusion. In this embodiment, a vibration annunciator may be included and the controller may turn on the vibration annunciator to provide an additional alert to a user that an intrusion has occurred.

In a second embodiment, local controller 106 may not be part of the mesh LAN comprising sensor packages 102. Instead, sensor packages 102 communicate with a centralized control and monitoring station over the mesh LAN (i.e. short haul LAN). The centralized control and monitoring station then communicates with one or more remote user controllers via a long haul RF network. The centralized control and monitoring station may include, for example, a gateway (and possibly a backup gateway) to one or more other networks. In yet another embodiment, the plurality of sensor packages 102 communicate both with one or more local user controllers 106 and with a centralized control and monitoring station that, in turn, communicates with one or more remote controllers. The remote controllers may be carried, for example, by border patrol agents, enabling them to respond to potential border breaches.

In operation, when a sensor package of the plurality of sensor packages 102 detects a disturbance, it alerts the local controller 106 and other nearby sensor packages. The sensor packages 102 then begin processing the data in an attempt to characterize and/or identify the disturbance. Disturbance information, such as empirical data and/or suspect waveforms, may be maintained at the local controller 106, for example, for use in comparing the detected disturbance data with the stored disturbance information. In addition or as an alternative, the sensor packages 102 could communicate the detected disturbance data over a long-haul communication link with one or more remote users or a central facility. As yet another alternative, the sensor packages 102 could obtain detailed stored disturbance information from a remote site, such as the central facility.

Alerts are preferably sent in a plurality of directions (e.g. both directions along a border) to existing towers, networks, and mobile terminals. The sensor spacing preferably allows for messaging around a disabled node (i.e. each sensor package should be able to communicate with more than one other sensor package in any general direction).

The system 100 described above provides unmanned coverage of target areas for long periods of time, due to relatively low power consumption. The sensor packages 102 may be small, lightweight, and expendable, making placement easy and inexpensive. The flexible architecture allows additional sensor packages 102 to be added to expand or alter a particular target area 104. By arranging the placement of the sensor packages 102 appropriately, underground disturbances can be detected to prevent intruders from breaching borders, boundaries, buildings, and other assets to be secured.

Variations and modifications of the present invention will be obvious to those skilled in the art and it is intended to cover in the appended claims all such modifications and equivalents. The entire disclosures of all references, applications, patents, and publications cited above, are hereby incorporated by reference.

We claim:

1. A system for detecting underground disturbances, comprising:
at least one sensor package, wherein the at least one sensor package comprises a seismic sensor, a processor, a battery, a radio, and an antenna, the at least one sensor package detecting seismic disturbances and generating an alert upon detection of the seismic disturbances; and
a local controller in communication with the at least one sensor package via an ad-hoc mesh network, wherein the at least one sensor package transmits the alert to the local controller.

2. The system as in claim 1, wherein at least one sensor package is split into two separate enclosures connected by a cable.

3. The system as in claim 1, wherein each sensor package of the at least one sensor package includes additional sensors capable of detecting tunnels or tunneling activity.

4. The system as in claim 1, wherein the alert comprises location information of the intrusion.

5. The system as in claim 4, wherein the location information includes geographic coordinates of the location of the intrusion.

6. The system as in claim 1, wherein the ad-hoc mesh network is controlled locally.

7. The system as in claim 1, wherein the ad-hoc mesh network is linked to a larger communications network for remote command and control.

8. The system as in claim 1, further comprising an annunciator, wherein the annunciator comprises a radio that is in communication with the local controller, and in response to receiving a signal from the local controller over the radio the annunciator vibrates to alert a user of an intrusion.

9. The system as in claim 8, wherein the local controller communicates with the annunciator via a wireless communication link.

10. The system as in claim 1, wherein the local controller is housed in a personal data assistant.

11. The system as in claim 1, wherein the local controller is housed in a computer.

12. The system as in claim 1, wherein the local controller comprises a display.

13. A system for detecting underground disturbances, comprising:
a plurality of sensors in an ad-hoc mesh network, each sensor package comprising a sensor, a processor, a battery, a radio, and an antenna, wherein the sensor is selected from a group consisting of acoustic sensors, magnetic anomaly sensors, and density anomaly sensors, wherein the sensor packages detect possible tunneling activity and generate an alert upon detecting the possible tunnel activity; and
a controller adapted to communicate with the ad-hoc mesh network for receiving the alert.

14. The system described in claim 13, wherein each sensor package additionally comprises a seismic sensor.
